(19) United States
(12) Patent Application Publication
(10) Pub. No.: US 2026/0167208 A1
(43) Pub. Date: Jun. 18, 2026

(54) SYSTEM AND METHOD OF OPERATING SYSTEM

(71) Applicant: TOYOTA JIDOSHA KABUSHIKI KAISHA, Toyota-shi (JP)

(72) Inventors: Taisuke TONE, Toyota-shi (JP); Hiroaki Kimura, Niiza-shi (JP); Takahiro Tsuchiya, Toyota-shi (JP)

(73) Assignee: TOYOTA JIDOSHA KABUSHIKI KAISHA, Toyota-shi (JP)

(21) Appl. No.: 19/389,448

(22) Filed: Nov. 14, 2025

(30) Foreign Application Priority Data
Nov. 21, 2024 (JP) 2024-203512

(51) Int. Cl. B60W 50/00; B60K 35/10; B60R 16/037; H04W 4/46

(52) U.S. Cl. CPC B60W 50/0098; B60K 35/10; B60R 16/0373; H04W 4/46

(57) ABSTRACT

A system includes a first in-vehicle apparatus that is mounted in a first vehicle and that has a suggestion model generated by machine-learning combinations of first inputs by first users of the first vehicle and first operations of the first vehicle in response to the first inputs, and a second in-vehicle apparatus that is mounted in a second vehicle of a different vehicle type from the first vehicle and that determines, using the suggestion model acquired from the first in-vehicle apparatus, a second operation of the second vehicle in response to a second input by a second user of the second vehicle.

### CROSS-REFERENCE TO RELATED APPLICATION

This application claims priority to Japanese Patent Application No. 2024-203512, filed on November 21, 2024, the entire contents of which are incorporated herein by reference.

### TECHNICAL FIELD

The present disclosure relates to a system and a method of operating the system.

### BACKGROUND

Technology for controlling operations of vehicles according to the preferences of users of the vehicles has been proposed. For example, Patent Literature (PTL) 1 discloses an example of systems that associate information on the settings of vehicle interior environment with identification information on users, and make the settings of vehicle interior environment that each user prefers.

### CITATION LIST

### Patent Literature

### PTL 1: JP 2019-182096 A

### SUMMARY

When in-vehicle apparatuses to be mounted in vehicles differ from vehicle type to vehicle type, there are variations in convenience that users enjoy from operations of the vehicles controlled by the in-vehicle apparatuses. Thus, there is room to enhance and further improve the level of user convenience.

Hereinafter, a system and the like that can improve user convenience will be disclosed.

A system according to the present disclosure includes:

a first in-vehicle apparatus mounted in a first vehicle, the first in-vehicle apparatus having a suggestion model generated by machine-learning a combination of a first input by a first user of the first vehicle and a first operation of the first vehicle in response to the first input; and

a second in-vehicle apparatus mounted in a second vehicle of a different vehicle type from the first vehicle, the second in-vehicle apparatus being configured to determine, using the suggestion model acquired from the first in-vehicle apparatus, a second operation of the second vehicle in response to a second input by a second user of the second vehicle.

Another aspect of the present disclosure is a method of operating a system including first and second in-vehicle apparatuses mounted in first and second vehicles of different vehicle types, respectively, the method including:

having, by the first in-vehicle apparatus, a suggestion model generated by machine-learning a combination of a first input by a first user of the first vehicle and a first operation of the first vehicle in response to the first input; and

determining, by the second in-vehicle apparatus using the suggestion model acquired from the first in-vehicle apparatus, a second operation of the second vehicle in response to a second input by a second user of the second vehicle.

According to the system and the like in the present disclosure, it is possible to improve user convenience.

### BRIEF DESCRIPTION OF THE DRAWINGS

In the accompanying drawings:

FIG. 1 is a diagram illustrating an example configuration of an information provision system;

FIG. 2 is a diagram illustrating an example configuration of an in-vehicle apparatus;

FIG. 3 is a flowchart illustrating an example operation procedure of the in-vehicle apparatus; and

FIG. 4 is a flowchart illustrating an example operation procedure of the in-vehicle apparatus.

### DETAILED DESCRIPTION

An embodiment will be described below with reference to the drawings.

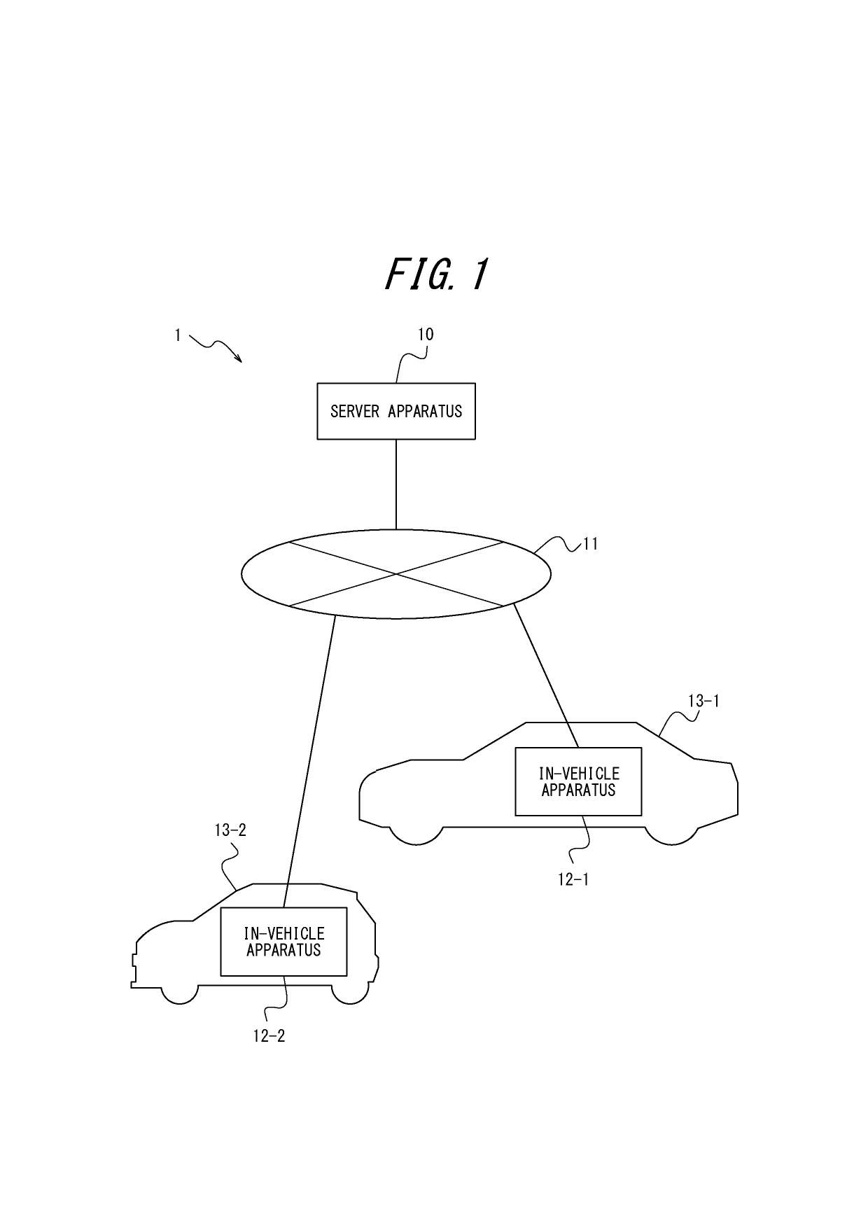

FIG. 1 is a diagram illustrating an example configuration of a vehicle control system according to the embodiment. A vehicle control system 1 includes at least one server apparatus 10 and in-vehicle apparatuses 12-1 and 12-2 mounted in vehicles 13-1 and 13-2, respectively, which are communicably connected to each other via a network 11. The server apparatus 10 is, for example, one or more server computers that belong to a cloud computing system or another computing system and that function as a server that implements various functions. The vehicles 13-1 and 13-2 are different types of passenger cars, commercial vehicles, or the like, and include internal combustion engine vehicles, Hybrid Electric Vehicles (HEVs), Plug-in Hybrid Electric Vehicles (PHEVs), or the like. The in-vehicle apparatuses 12-1 and 12-2 are computers that have communication functions and information processing functions, and control operations of the vehicles 13-1 and 13-2, respectively. The network 11 may include, for example, a mobile communication network, the Internet, an ad hoc network, a local area network (LAN), a metropolitan area network (MAN), other networks, or any combination thereof.

In the present embodiment, the vehicle 13-1 is a higher-class model than the vehicle 13-2. For example, the vehicle 13-1 belongs to a so-called high-end vehicle category, while the vehicle 13-2 belongs to a so-called low-end vehicle category that is less expensive than high-end vehicles. The vehicle 13-1 is provided with equipment to provide more sophisticated user experiences than the vehicle 13-2, and the in-vehicle apparatus 12-1 is configured to perform control that offers more user convenience than the in-vehicle apparatus 12-2. In the present embodiment, reducing the imbalance in user convenience between the vehicles 13-1 and 13-2 and enhancing the level of user convenience in the vehicle 13-2 improve the user convenience of the vehicles 13-1 and 13-2 as a whole.

In the present embodiment, the in-vehicle apparatus 12-1 has a suggestion model that has machine-learned combinations of inputs from users of the vehicle 13-1 (one or more users including drivers and passengers, hereinafter referred to as high-end vehicle users) and operations of the vehicle 13-1 (hereinafter referred to as high-end vehicle operations) in response to the inputs. The in-vehicle apparatus 12-1 also updates the suggestion model, using combinations of the high-end vehicle operations and the reactions of the high-end vehicle users to those operations. The in-vehicle apparatus 12-2 determines, using the suggestion model acquired from the in-vehicle apparatus 12-1, an operation of the vehicle 13-2 (hereinafter referred to as a low-end vehicle operation) in response to an input from a use of the vehicle 13-2 (at least one user including a driver or a passenger, hereinafter referred to as a low-end vehicle user). Here, the inputs from the high-end vehicle users or low-end vehicle user are intentional inputs made by each user, and spoken content corresponding to wishes and preferences of each user. Such inputs are hereinafter referred to as intentional inputs. The reactions of the high-end vehicle users to the high-end vehicle operations are various actions taken by the high-end vehicle users, including physical conditions such as body temperature and pulse, signs of drowsiness or discomfort in captured images, and operations on air conditioning or audio. According to the vehicle control system 1, it is possible to realize the more sophisticated low-end vehicle operation in response to the input from the low-end vehicle user by using, in the in-vehicle apparatus 12-2, the suggestion model that has been updated in the in-vehicle apparatus 12-1 through reinforcement learning using the reactions of the high-end vehicle users. Therefore, user convenience can be improved as a whole.

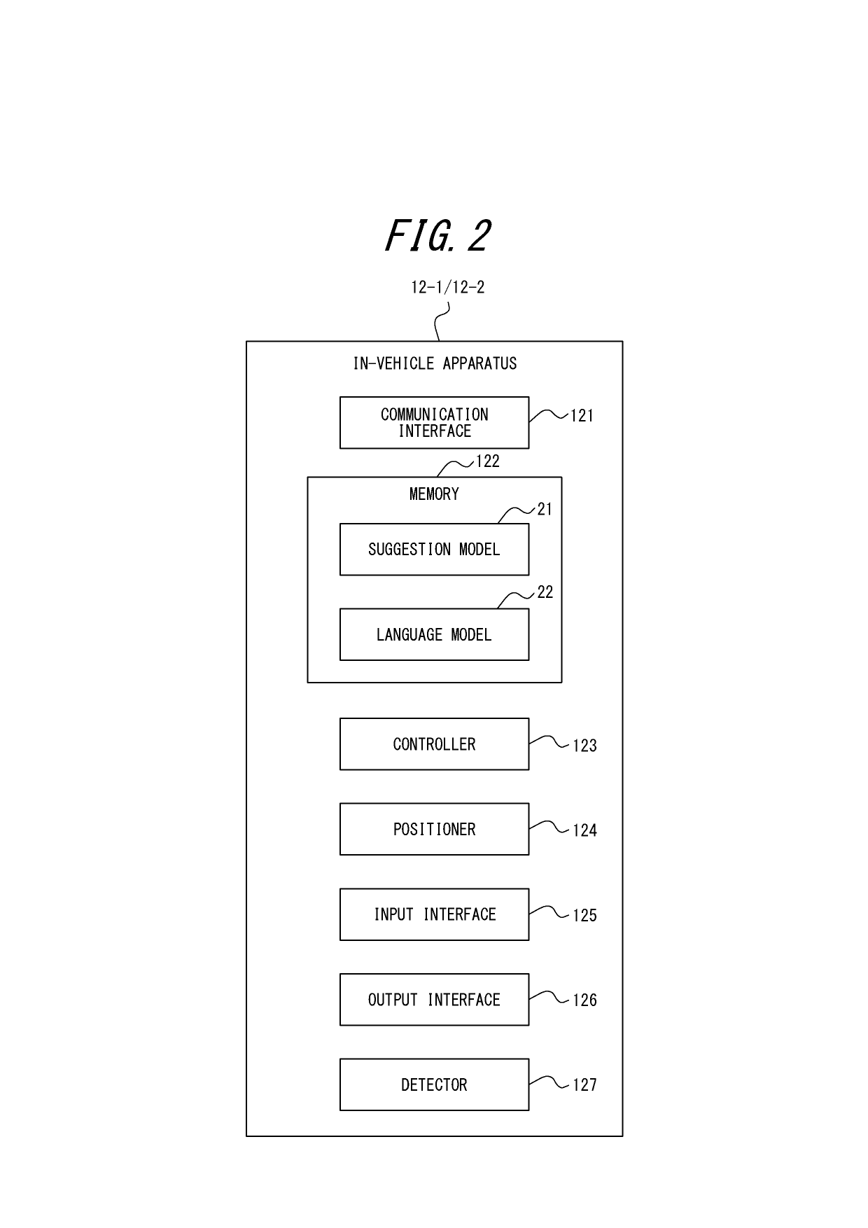

FIG. 2 illustrates an example configuration of the in-vehicle apparatuses 12-1 and 12-2. The in-vehicle apparatuses 12-1 and 12-2 are configured equivalently in the following respects. That is, the in-vehicle apparatus 12-1, 12-2 has a communication interface 121, a memory 122, a controller 123, a positioner 124, an input interface 125, an output interface 126, and a detector 127. These components may be configured as a single control apparatus, as two or more control apparatuses, or with another apparatus such as a control apparatus and a communication device. The control apparatus includes, for example, an electronic control unit (ECU) or the like. The communication device includes, for example, a data communication module (DCM) or the like. The components are communicably connected to each other or to equipment in the vehicle 15, by an in-vehicle network compliant with a standard such as a controller area network (CAN). The in-vehicle apparatus 12-1, 12-2 may be configured to include an information processing apparatus such as a smartphone or tablet terminal.

The communication interface 121 has a module compliant with a mobile communication standard such as Long Term Evolution (LTE), 4th Generation (4G), or 5th Generation (5G), a module compliant with in-vehicle LAN such as CAN, or the like. The in-vehicle apparatus 12 performs, via the communication interface 121, information communication with other apparatuses via the network 11 connected through a nearby router apparatus or a mobile communication base station, and information communication with each component of the vehicle 13-1, 13-2 via the in-vehicle LAN.

The memory 122 includes one or more semiconductor memories, one or more magnetic memories, one or more optical memories, or a combination of at least two of these types. The semiconductor memories are, for example, random access memory (RAM) or read only memory (ROM). The RAM is, for example, static RAM (SRAM) or dynamic RAM (DRAM). The ROM is, for example, electrically erasable programmable ROM (EEPROM). The memory 122 functions as, for example, a main memory, an auxiliary memory, or a cache memory. The memory 122 stores information to be used for operations of the controller 123 and information obtained by the operations of the controller 123. In the present embodiment, the memory 122 stores a suggestion model 21 and a language model 22.

The suggestion model 21 has been generated in advance through machine learning using combinations of intentional inputs from high-end vehicle users and high-end vehicle operations as training data, and has been stored in the in-vehicle apparatus 12-1. In the vehicle 13-1, the suggestion model 21 suggests a high-end vehicle operation in response to an intentional input from a high-end vehicle user. Here, the suggestion includes an instruction for executing the high-end vehicle operation for the vehicle 13-1. The in-vehicle apparatus 12-1 updates the suggestion model 21 through reinforcement learning using reactions of the high-end vehicle users, as described in the following procedure. The updated suggestion model 21 is transmitted from the in-vehicle apparatus 12-1 to the in-vehicle apparatus 12-2 via the server apparatus 10, and is stored in the in-vehicle apparatus 12-2. In the vehicle 13-2, the suggestion model 21 suggests a low-end vehicle operation in response to an intentional input from a low-end vehicle user.

The language model 22 is a model that has been generated by machine-learning patterns, structures, and meanings of natural language from a large amount of text data, to generate, summarize, or analyze sentences by natural language. For example, the language model 22 is a relatively small language model based on a transformer architecture, having several millions to several hundreds of millions of parameters. In the in-vehicle apparatuses 12-1 and 12-2, the format, scale, or the like of the language model 22 may differ.

The controller 123 includes one or more processors, one or more dedicated circuits, or a combination thereof. The processors are general purpose processors such as central processing units (CPUs), or dedicated processors such as graphics processing units (GPUs) specialized for particular processing. The dedicated circuits are, for example, field-programmable gate arrays (FPGAs), application specific integrated circuits (ASICs), or the like. The controller 123 executes information processing related to operations of the in-vehicle apparatus 12 while controlling components of the in-vehicle apparatus 12.

The functions of the controller 123 are realized by execution of a control/processing program by a processor included in the controller 123. The control/processing program is a program for causing a computer to execute processing of steps included in the operations of the controller 123, thereby enabling the computer to realize the functions corresponding to the processing of the steps. That is, the control/processing program is a program for causing a computer to function as the controller 123. Some or all of the functions of the controller 123 may be realized by a dedicated circuit included in the controller 123.

The positioner 124 includes one or more global navigation satellite system (GNSS) receivers. The GNSS includes, for example, global positioning system (GPS), quasi-zenith satellite system (QZSS), BeiDou, global navigation satellite system (GLONASS), and/or Galileo. The positioner 124 transmits a positioning result to the controller 123, and the controller 123 calculates positional information on the in-vehicle apparatus 12.

The input interface 125 includes one or more interfaces for input. The interfaces for input include, for example, a microphone that accepts audio input, physical keys, capacitive keys, a pointing device, a touch screen integrally provided with a display, or the like. The interfaces for input also include a camera that captures images of the interior of the vehicle. The input interface 125 accepts operations for inputting various information, including spoken voice of a user, and transmits the input information to the controller 123 or transmits the captured images to the controller 123.

The output interface 126 includes one or more interfaces for output. The interfaces for output include, for example, a speaker or a display. The display is, for example, a liquid crystal display (LCD) or an organic electro-luminescence (EL) display. The output interface 126 outputs information obtained by operations of the controller 123.

The detector 127 has interfaces with one or more sensors that detect the states of various parts of the vehicles 13-1 and 13-2, or has the one or more sensors. The sensors include, for example, sensors for vehicle speed, acceleration, and the like, and sensors for indoor and outdoor temperature, humidity, and the like. The sensors of the detector 127 in the in-vehicle apparatus 12-1 further include sensors that measure and detect the physical conditions such as body temperature and pulse of high-end vehicle users using infrared rays or other means, sensors that detect operation amounts for in-vehicle equipment such as air conditioning and audio by the high-end vehicle users, and other sensors.

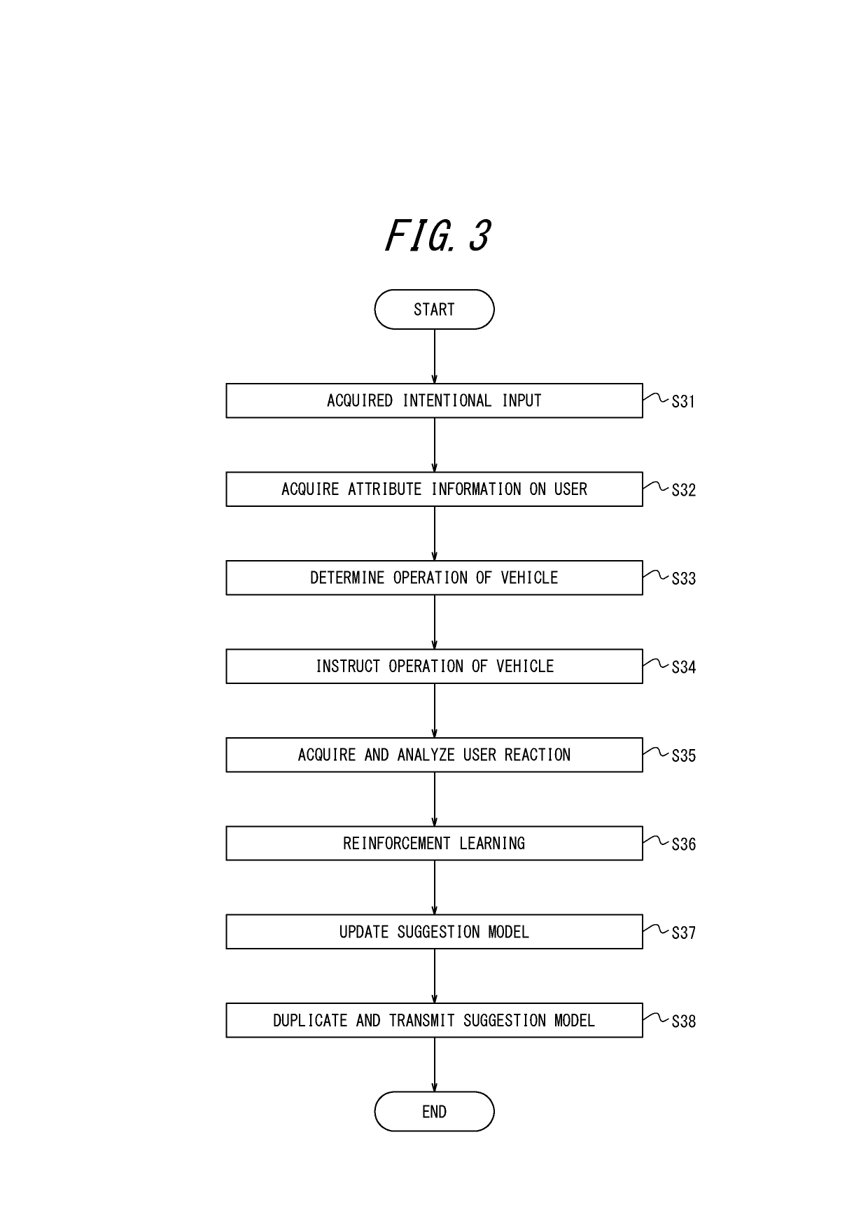

FIG. 3 is a flowchart illustrating an operation procedure of the in-vehicle apparatus 12-1 for reinforcement learning of the suggestion model 21. Each step in FIG. 3 is a step of information processing executed by the controller 123 of the in-vehicle apparatus 12-1.

In S31, the controller 123 acquires an intentional input. The controller 123 acquires spoken voice from a high-end vehicle user through the input interface 125. The controller 123 converts spoken content into text through, for example, voice recognition processing, and inputs the text to the language model 22, to acquire an intentional input corresponding to the spoken content from the language model 22. The intentional input corresponds to the spoken content that indicates the condition of the high-end vehicle user, including anxiety, tension, drowsiness, boredom, concentration, or discomfort, such as "I want to go to XX," "I want to listen to the song XX," "I want to focus on driving," or "I want to refresh myself."

In S32, the controller 123 acquires attribute information on the user. The controller 123 acquires attribute information on the high-end vehicle user from, for example, the server apparatus 10. The attribute information includes, for example, information such as the age, gender, residence, and occupation of the high-end vehicle user. The attribute information may be, in advance, transmitted to and stored in the server apparatus 10 from any information processing apparatus at the time of, for example, purchasing the vehicle 13-1. The attribute information may be stored in the server apparatus 10 in any text format or the like. The attribute information may be acquired from posted content or the like of the high-end vehicle user on Social Network Service (SNS). The controller 123 can acquire the attribute information by collecting various types of text and posted content from various servers, and analyzing the text and posted content using the language model 22 or a large-scale language model held by the server apparatus 10.

In S33, the controller 123 determines an operation of the vehicle 13-1. The controller 123 inputs the intentional input from the high-end vehicle user to the suggestion model 21, and determines, using the suggestion model 21, a corresponding operation of the vehicle 13-1, that is, a high-end vehicle operation. The determined high-end vehicle operation includes, for example, an adjustment of air conditioning temperature or humidity corresponding to the intentional input of the high-end vehicle user, an adjustment of audio (song selection, volume adjustment), a recommendation (voice output) for a parking or stopping location, or the like. Furthermore, the controller 123 may determine the operation of the vehicle 13-1 taking into account the attribute information on the high-end vehicle user. For example, the controller 123 performs settings for air conditioning or song selections according to the age and gender of the high-end vehicle user. Setting information for air conditioning, information on songs, and the like suitable for each age group and gender are stored in advance in the memory 122. The controller 123 selects a parking or stopping location close to the residence or workplace of the high-end vehicle user based on map information. The map information is stored in advance in the memory 122. For example, when the high-end vehicle user is a male corporate employee in his 50s and the time is in the afternoon, the high-end vehicle user is likely to be wearing a suit, so the air conditioning can be set to a lower temperature and a higher airflow. When the high-end vehicle user is a woman in her 60s and the season is summer, the high-end vehicle user is likely to be wearing lightly, so the temperature should not be set too low and the airflow should be reduced.

In S34, the controller 123 instructs the operation of the vehicle 13-1. The controller 123 transmits an instruction to execute the high-end vehicle operation, to equipment, an actuator, or the like of the vehicle 13-1 to realize the high-end vehicle operation. The instruction includes, for example, an instruction for an adjustment of temperature or humidity for an air conditioning system, an instruction for song selection, volume adjustment, or the like for an audio system, an instruction for voice output by the output interface 126 for a parking or stopping location, or the like.

In S35, the controller 123 acquires and analyzes a reaction of the user. The controller 123 acquires a reaction of the high-end vehicle user, from the physical condition of the high-end vehicle user and an operation on the vehicle 13-1 acquired by the detector 127, captured images acquired by the input interface 125, or the like. The controller 123 analyzes the reaction of the high-end vehicle user and determines whether the reaction is a positive reaction or a negative reaction to the most recent high-end vehicle operation. For example, in a case in which the temperature or humidity has been changed, the reaction can be classified as a positive reaction when a proper body temperature and a proper pulse rate corresponding to the changed temperature or humidity are obtained. Otherwise, the reaction is classified as a negative reaction. Information on the proper body temperature and the proper pulse rate for each temperature or humidity is set freely in advance and stored in the memory 122. In the captured images, when the high-end vehicle user who has been indicating signs of drowsiness or discomfort indicates signs of awakening or comfort, the reaction is determined as a positive reaction. Otherwise, the reaction is determined as a negative reaction. The controller 123 derives a pattern of the actions, expressions, and gestures of the high-end vehicle user through image processing on sequential frames, and determines whether the user indicates signs of awakening or comfort by matching the derived pattern with a pre-set pattern. Alternatively, when a cancellation or opposing operation by the high-end vehicle user is detected in response to a change in temperature or humidity or a change in audio, the reaction is determined as a negative reaction.

In S36, the controller 123 performs reinforcement learning of the suggestion model 21. The controller 123 executes steps S31 to S34 a predetermined number of times at any intervals, for example, every few seconds, to acquire combinations of intentional inputs and high-end vehicle operations in response thereto, and combinations of the high-end vehicle operations and reactions thereto. The controller 123 executes reinforcement learning of the suggestion model 21 using positive reactions as rewards through any algorithm. Step S36 can be executed at any frequency. Step S36 may be executed, for example, for each single travel of the vehicle 13-1, or at any intervals, such as every few days.

In S37, the controller 123 updates the suggestion model 21 with one after the reinforcement learning, and stores the updated suggestion model 21 in the memory 122.

In S38, the controller 123 duplicates the suggestion model 21, and transmits information on the duplicated suggestion model 21 to the in-vehicle apparatus 12-2. The in-vehicle apparatus 12-2 receives the information on the duplicated suggestion model 21 via the server apparatus 10 and stores the duplicated suggestion model 21 in the memory 122, so the updated suggestion model 21 is shared among the in-vehicle apparatuses 12-1 and 12-2. Step S38 may be executed every time the suggestion model 21 is updated in step S37, or step S38 may be executed when the suggestion model 21 is updated any multiple times.

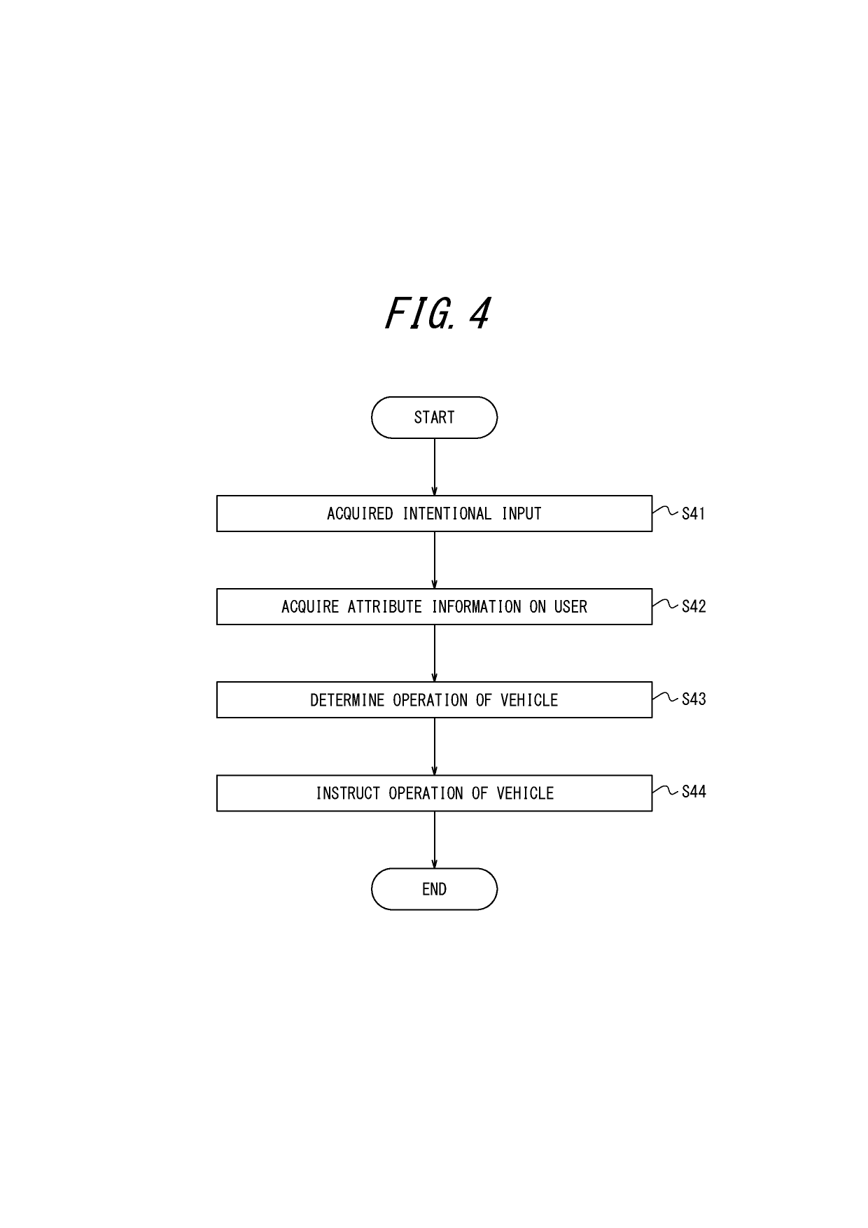

FIG. 4 is a flowchart illustrating an operation procedure of the in-vehicle apparatus 12-2 after acquiring the suggestion model 21. Each step in FIG. 4 is a step of information processing executed by the controller 123 of the in-vehicle apparatus 12-2.

In S41, the controller 123 acquires an intentional input. The controller 123 acquires spoken voice from a low-end vehicle user through the input interface 125. The controller 123 converts spoken content into text through, for example, voice recognition processing, and inputs the text to the language model 22, to acquire an intentional input corresponding to the spoken content from the language model 22. The intentional input corresponds to the spoken content that indicates the condition of the low-end vehicle user, including anxiety, tension, drowsiness, boredom, concentration, or discomfort, such as "I want to go to XX," "I want to listen to the song XX," "I want to focus on driving," or "I want to refresh myself."

In S42, the controller 123 acquires attribute information on the user. The controller 123 acquires attribute information on the low-end vehicle user from, for example, the server apparatus 10. The attribute information includes, for example, information such as the age, gender, residence, and occupation of the low-end vehicle user. The attribute information is, in advance, transmitted to and stored in the server apparatus 10 from any information processing apparatus at the time of, for example, purchasing the vehicle 13-2. The attribute information may be stored in the server apparatus 10 in any text format or the like. The attribute information may be acquired from posted content or the like of the low-end vehicle user on SNS. The controller 123 can acquire the attribute information by collecting various types of text and posted content from various servers, and analyzing the text and posted content using the language model 22 or a large-scale language model held by the server apparatus 10.

In S43, the controller 123 determines an operation of the vehicle 13-2. The controller 123 inputs the intentional input from the low-end vehicle user to the suggestion model 21, and determines, using the suggestion model 21, a corresponding operation of the vehicle 13-2, that is, a low-end vehicle operation. The determined low-end vehicle operation includes, for example, an adjustment of air conditioning temperature or humidity corresponding to the intentional input of the low-end vehicle user, an adjustment of audio (song selection, volume adjustment), a recommendation (voice output) for a parking or stopping location, or the like. Furthermore, the controller 123 may determine the operation of the vehicle 13-2 taking into account the attribute information on the low-end vehicle user. For example, the controller 123 performs settings for air conditioning or song selections according to the age and gender of the low-end vehicle user. Setting information for air conditioning, information on songs, and the like suitable for each age group and gender are stored in advance in the memory 122. The controller 123 selects a parking or stopping location close to the residence or workplace of the low-end vehicle user based on map information. The map information is stored in advance in the memory 122.

In S44, the controller 123 instructs the operation of the vehicle 13-2. The controller 123 transmits an instruction to execute the low-end vehicle operation, to equipment, an actuator, or the like of the vehicle 13-2 to realize the low-end vehicle operation. The instruction includes, for example, an instruction for an adjustment of temperature or humidity for an air conditioning system, an instruction for song selection, volume adjustment, or the like for an audio system, an instruction for voice output by the output interface 126 for a parking or stopping location, or the like.

As described above, the low-end vehicle operation based on the intentional input of the low-end vehicle user is executed in the vehicle 13-2, using the suggestion model 21 acquired from the vehicle 13-1. Therefore, according to the present embodiment, user convenience can be improved.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A system comprising:
a first in-vehicle apparatus mounted in a first vehicle, the first in-vehicle apparatus being configured to generate a suggestion model by machine-learning a combination of a first input by a first user of the first vehicle and a first operation of the first vehicle in response to the first input, and a combination of the first operation and a reaction of the first user to the first operation; and
a second in-vehicle apparatus mounted in a second vehicle of a different vehicle type from the first vehicle, the second in-vehicle apparatus being configured to determine, using the suggestion model acquired from the first in-vehicle apparatus, a second operation of the second vehicle in response to a second input by a second user of the second vehicle.

2. A system comprising:
a first in-vehicle apparatus mounted in a first vehicle, the first in-vehicle apparatus having a suggestion model generated by machine-learning a combination of a first input by a first user of the first vehicle and a first operation of the first vehicle in response to the first input; and
a second in-vehicle apparatus mounted in a second vehicle of a different vehicle type from the first vehicle, the second in-vehicle apparatus being configured to determine, using the suggestion model acquired from the first in-vehicle apparatus, a second operation of the second vehicle in response to a second input by a second user of the second vehicle.

3. The system according to claim 2, wherein the first in-vehicle apparatus is configured to update the suggestion model by further machine-learning a combination of the first operation and a reaction of the first user to the first operation.

4. The system according to claim 2, wherein the first in-vehicle apparatus is configured to update the suggestion model by further using attribute information on the first user.

5. The system according to claim 4, wherein the first in-vehicle apparatus is configured to acquire the attribute information on the first user using a language model.

6. The system according to claim 2, wherein the second in-vehicle apparatus is configured to determine the second operation by further using attribute information on the second user.

7. The system according to claim 6, wherein the second in-vehicle apparatus is configured to acquire the attribute information on the second user using a language model.

8. The system according to claim 2, wherein the first input includes spoken content by the first user.

9. The system according to claim 2, wherein the second input includes spoken content by the second user.

10. A method of operating a system including first and second in-vehicle apparatuses mounted in first and second vehicles of different vehicle types, respectively, the method comprising:
having, by the first in-vehicle apparatus, a suggestion model generated by machine-learning a combination of a first input by a first user of the first vehicle and a first operation of the first vehicle in response to the first input; and
determining, by the second in-vehicle apparatus using the suggestion model acquired from the first in-vehicle apparatus, a second operation of the second vehicle in response to a second input by a second user of the second vehicle.

11. The method according to claim 10, wherein the first in-vehicle apparatus is configured to update the suggestion model by further machine-learning a combination of the first operation and a reaction of the first user to the first operation.

12. The method according to claim 10, wherein the first in-vehicle apparatus is configured to update the suggestion model by further using attribute information on the first user.

13. The method according to claim 12, wherein the first in-vehicle apparatus is configured to acquire the attribute information on the first user using a language model.

14. The method according to claim 10, wherein the second in-vehicle apparatus is configured to determine the second operation by further using attribute information on the second user.

15. The method according to claim 14, wherein the second in-vehicle apparatus is configured to acquire the attribute information on the second user using a language model.

16. The method according to claim 10, wherein the first input includes spoken content by the first user.

17. The method according to claim 10, wherein the second input includes spoken content by the second user.
